(19) United States
(12) Patent Application Publication
(10) Pub. No.: US 2006/0083137 A1
(43) Pub. Date: Apr. 20, 2006

(54) Data recording method and system

(75) Inventors: Yen-Ying Lai, Taipei County (TW); Wei-Tse Hsu, Taipei City (TW); Yung-Chih Hsu, Taipei County (TW)

Correspondence Address: QUINTERO LAW OFFICE, 1617 BROADWAY, 3RD FLOOR, SANTA MONICA, CA, 90404, US

(73) Assignee: BENQ CORPORATION, TAOYUAN (TW)

(21) Appl. No.: 11/250,910

(22) Filed: Oct. 13, 2005

(30) Foreign Application Priority Data
Oct. 15, 2004 (TW) TW93131302

(51) Int. Cl. G11B 7/00

(52) U.S. Cl. 369/53.2; 369/47.1; 369/275.1

(57) ABSTRACT

A data recording method for recordable disks. The recordable disk includes a non-border area and multiple border areas. Data is recorded in the non-border area and buffer areas in a single data write. Data is then recorded in the border areas of the recordable disk. The single data write requires only one data write initiation and one data write termination.

### BACKGROUND

The present invention relates to data recording methods, and in particular to data recording methods and systems for optical storage media.

Optical storage media, such as recordable disks, is generally partitioned for data recording. For example, a Digital Video Disk (DVD) can be divided into non-border areas and border areas for data recording according to specifications, such as DVD specification for recordable disk for general. The border areas may include border-in and border-out areas. Actual data is recorded in the non-border areas of a recordable disk, while information related to the recordable disk itself is recorded in the border-in and border-out areas, as shown in FIG. 1.

Buffer areas (Linking Loss Area, LLA) may be located between the border-in area and the non-border area or between the border-out area and the non-border area. The buffer areas record empty bits or isolation bits. As shown in FIG. 1, a first buffer area (LLA 1) 16 is located between the rear of the border-in area 12 and the non-border area 10. Another buffer area (LLA 2) 18, i.e. a second buffer area, is located between the front of the border-out area 14 and the non-border area 10.

Data is sequentially recorded in the non-border area 10, then the border-in area 12 and the first buffer area (LLA 1), and finally the border-out area 14 and the second buffer area (LLA 2) 18 according to conventional data recording methods. The data can be recorded in one or multiple data writes.

FIG. 2 is a flowchart of an embodiment of a conventional data recording method for recordable disks. A first data write is executed (step S20) as follows. The first data write is initiated. The data is recorded in the non-border area. The first data write is then terminated. A second data write is executed (step S22). The second data write is initiated. The data is recorded in the border-in area and the first buffer area (LLA 1). The second data write is then terminated. A third data write is executed (step S24). The third data write is initiated. The data is recorded in the border-out area and the second buffer area (LLA 2). The third data write is then terminated.

Data recording of the non-border area and the buffer areas is accomplished in different data writes. The data recorded in the buffer areas may shift as shown in FIG. 3, a diagram of an exemplary data shift of buffer areas. Since data in the non-border area is recorded prior to the data in the buffer areas, when the data of the buffer areas is shifted, the data in the non-border area is affected, as indicated by the oblique line areas shown in FIG. 3.

The data shift is often caused by mechanical problems in data write initiation and termination of the data recording device. Data recorded in the non-border area is unrecoverable and has high-priority. Thus, data shift problems can incur serious data liability.

### SUMMARY

Data recording methods and systems for recordable disks are provided. In an exemplary embodiment, a recordable disk includes a non-border area and border areas. Data is recorded in the non-border area and buffer areas in a single data write. Data is then recorded in the border areas of the recordable disk. The single data write requires only one data write initiation and one data write termination.

### BRIEF DESCRIPTION OF THE DRAWINGS

Embodiments of the present invention can be more fully understood by reading the subsequent detailed description and examples with references made to the accompanying drawings, wherein:

FIG. 1 is a diagram of an exemplary format of a recordable disk.

FIG. 2 is a flowchart of a conventional data recording method for recordable disks.

FIG. 3 is a diagram of an exemplary data shift of buffer areas.

FIG. 4 is a flowchart of an embodiment of a data recording method for recordable disks.

FIG. 5 is a diagram of an embodiment of a machine-readable storage medium for storing a computer program providing a data recording method for recordable disks.

FIG. 6 is a diagram of an embodiment of a data recording system for recordable disks.

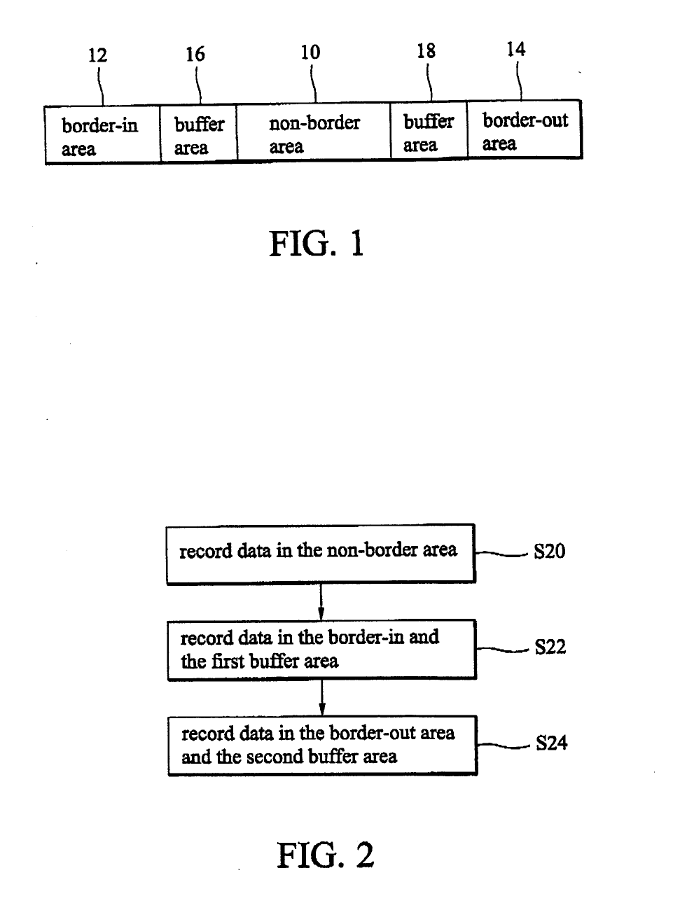

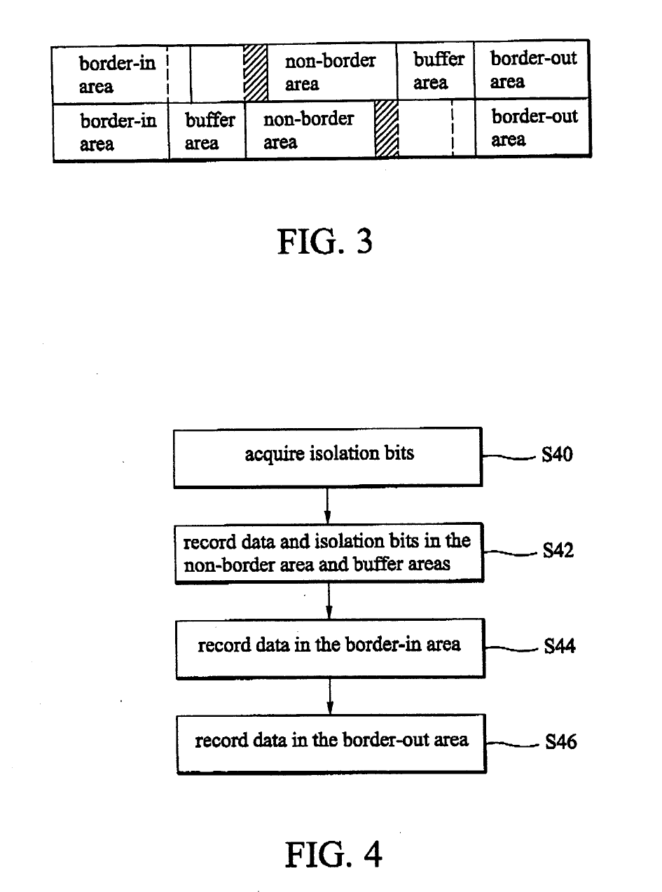

### DETAILED DESCRIPTION

FIG. 4 is a flowchart of an embodiment of a data recording method for recordable disks. In the embodiment, the recordable disk comprises a non-border area and several border areas. The border areas include a border-in area and a border-out area.

Isolation bits are acquired (step S40). Data and isolation bits are then recorded in the non-border area and buffer areas in a single data write (step S42). In step S42, the data is recorded in the non-border area in one data write initiation and one data write termination. The isolation bits are recorded in the buffer areas, located between the border-in area and the non-border area and between the border-out area and the non-border area, in the same data write initiation and data write termination.

Data is then recorded in the border areas of the recordable disk. Data may be first recorded in the border-in area (step S44) and then recorded in the border-out area (step S46). In step S42, the buffer areas can be reserved but not to record data. The buffer areas can be one area or multiple areas.

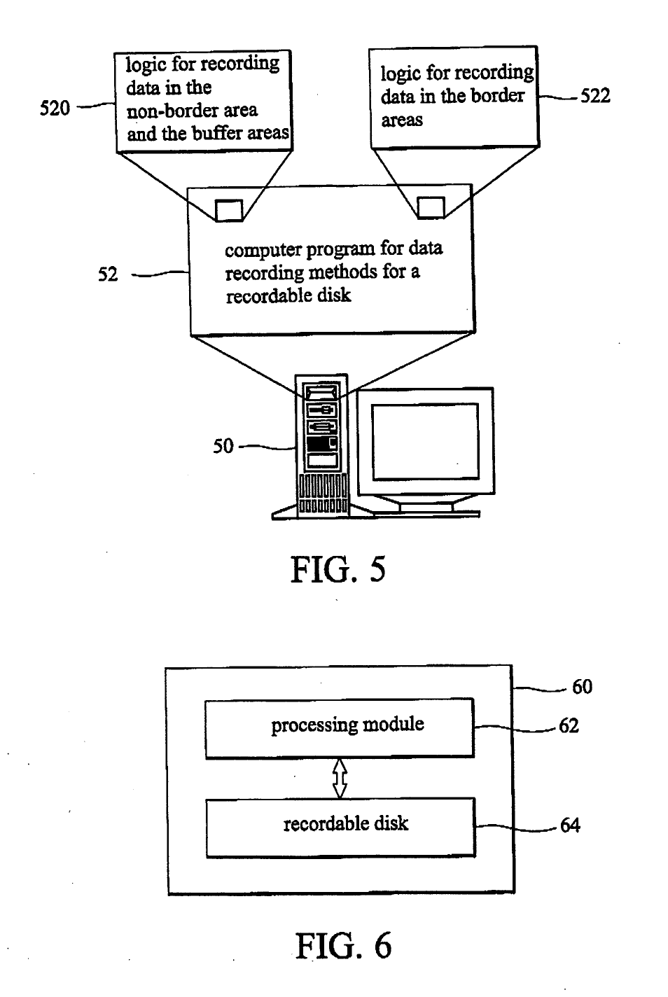

The method can be implemented in computer programs. FIG. 5 is a diagram of an embodiment of a machine-readable storage medium storing a computer program providing a data recording method for recordable disks. As shown in FIG. 5, machine-readable storage medium 50 stores a computer program 52. The computer program 52 mainly comprises logic for recording data in the non-border area and the buffer areas 520 and logic for recording data in the border areas 522.

FIG. 6 is a diagram of an embodiment of a data recording system for recordable disks. A data recording system 60, recording data in a recordable disk 64, comprises a processing module 62. The recordable disk 64 contains a non-border area and multiple border areas. The processing module 62 records data in the non-border area and buffer areas in a single data write and also records data in the border areas of the recordable disk 64 in another single data write.

In one embodiment, the processing module 62 acquires isolation bits. The processing module 62 records data and acquired isolation bits in the recordable disk 64.

In the embodiment, the recordable disk 64 includes a non-border area and several border areas. The border areas comprise a border-in area and a border-out area. The buffer areas may be located between the border-in area and the non-border area. The buffer areas may be located between the border-out area and the non-border area. The single data write requires only one data write initiation and one data write termination to be executed. The processing module 62 records data in the non-border area and the isolation bits in the buffer areas in one single data write. Thereafter, the processing module 62 records data in the border-in and border-out areas. The processing module 62 can be implemented in a chip.

Thus, embodiments of the present invention provide data recording methods and systems. Data shift problems can be resolved by improving data write execution.

It will be appreciated from the foregoing description that the methods and systems described herein provide a dynamic and robust solution to data shift problems. If, for example, the format of the recordable disk is changed, methods and systems of the present invention can be revised accordingly.

Methods of the present invention, or certain aspects or portions of embodiments thereof, may take the form of program code (i.e., instructions) embodied in media, such as floppy diskettes, CD-ROMS, hard drives, firmware, or any other machine-readable storage medium, wherein, when the program code is loaded into and executed by a machine, such as a computer, the machine becomes an apparatus for practicing and embodiment of the invention. The methods and apparatus of the present invention may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing and embodiment of the invention. When implemented on a general-purpose processor, the program code combines with the processor to provide a unique apparatus that operates analogously to specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalents.

What is claimed is:

1. A data recording method for recordable disks, wherein a recordable disk comprises a non-border area and at least one border area, the method comprising:
recording data in the non-border area and at least one buffer area in a single data write; and
recording data in the border areas of the recordable disk.

2. The data recording method for recordable disks as claimed in claim 1, wherein the border areas comprise a border-in area and/or a border-out area.

3. The data recording method for recordable disks as claimed in claim 2, wherein the buffer areas are located between the border-in area and the non-border area.

4. The data recording method for recordable disks as claimed in claim 2, wherein the buffer areas are located between the border-out area and the non-border area.

5. The data recording method for disks recordable disks as claimed in claim 1, wherein the single data write comprises only one data write initiation and one data write termination.

6. A machine-readable storage medium for storing a computer program providing a data recording method for recordable disks, wherein a recordable disk comprises a non-border area and at least one border area, the method comprising:
recording data in the non-border area and at least one buffer area in a single data write; and
recording data in the border areas of the recordable disk.

7. The machine-readable storage medium as claimed in claim 6, wherein the border areas comprise a border-in area and/or a border-out area.

8. The machine-readable storage medium as claimed in claim 7, wherein the buffer areas are located between the border-in area and the non-border area.

9. The machine-readable storage medium as claimed in claim 7, wherein the buffer areas are located between the border-out area and the non-border area.

10. The machine-readable storage medium as claimed in claim 6, wherein the single data write comprises only one data write initiation and one data write termination.

11. A data recording system for disks to record data in a recordable disk, wherein the recordable disk comprises a non-border area and at least one border area, comprising a processing module, recording data in the non-border area and at least one buffer area in a single data write and recording data in the border areas of the recordable disk in another single data write.

12. The data recording system for disks as claimed in claim 11, wherein the border areas comprise a border-in area and/or a border-out area.

13. The data recording system for disks as claimed in claim 12, wherein the buffer areas are located between the border-in area and the non-border area.

14. The data recording system for disks as claimed in claim 12, wherein the buffer areas are located between the border-out area and the non-border area.

15. The data recording system for disks as claimed in claim 11, wherein the single data write comprises only one data write initiation and one data write termination.

16. The data recording system for disks as claimed in claim 11, wherein the processing module is a chip.
